(19) United States
(12) Patent Application Publication
(10) Pub. No.: US 2010/0277940 A1
(43) Pub. Date: Nov. 4, 2010

(54) VEHICLE LAMP

(75) Inventor: Hiroyuki ISHIDA, Shizuoka (JP)

Correspondence Address: SUGHRUE-265550, 2100 PENNSYLVANIA AVE. NW, WASHINGTON, DC, 20037-3213, US

(73) Assignee: KOITO MANUFACTURING CO., LTD., Tokyo (JP)

(21) Appl. No.: 12/764,558

(22) Filed: Apr. 21, 2010

(30) Foreign Application Priority Data
Apr. 30, 2009 (JP) 2009-110516

(51) Int. Cl. B60Q 1/02

(52) U.S. Cl. 362/538

(57) ABSTRACT

A vehicle lamp includes a projection lens, an LED light source arranged behind a rear focal point of the projection lens such that an optical axis of the LED light source is oriented upward, a reflector which is arranged above he LED light source to reflect a first part of light emitted from the LED light source and to converge the first part of the light toward the rear focal point of the projection lens, a shade which is arranged between the projection lens and the reflector to partially block the first part of the light reflected by the reflector, and a first auxiliary reflector which is arranged above the LED light source and in front of the reflector to forwardly reflect a second part of the light emitted from the LED light source such that the second part of the light does not pass through the projection lens.

### CROSS-REFERENCE TO RELATED APPLICATIONS

The present application claims priority from Japanese Patent Application No. 2009-110516 filed on Apr. 30, 2009, the entire content of which is incorporated herein by reference.

### FIELD OF INVENTION

An apparatus consistent with the present invention relates to a vehicle lamp having a light emitting diode (LED) light source and a reflector which reflects a part of light from the LED light source so as to be incident on a projection lens.

### DESCRIPTION OF RELATED ART

Related art vehicle lamps use semiconductor light emitting devices, such as LEDs, as light sources due to their advantageous luminous efficiency and power consumption properties. In some of the related art vehicle lamps, an LED light source is disposed such that an optical axis of the LED light source is upwardly oriented, and a reflector is disposed to cover the LED light source from above, from the side, and from behind. Further, a shade is arranged between a projection lens and the LED light source. Light from the LED light source is reflected by the reflector, and a part of the reflected light is blocked by the shade to form a cut-off line of a light distribution pattern. The other part of the reflected light is forwardly irradiated through the projection lens (see, e.g., JP 2007-323839 A).

The light distribution pattern of these lamps has a light-condensed region adjacent to the cut-off line, and a light-diffused region surrounding the light-condensed region. The light-condensed region has higher illuminance than the light-diffused region. In most cases, the light-diffused region is formed by using light that is emitted in a substantially horizontal direction from the LED light source.

However, LEDs have the characteristic that luminous intensity of light emitting therefrom decreases as it moves away from the optical axis. Therefore, in the case of the vehicles lamps described above, it is difficult to ensure the sufficient illuminance required for the light-diffused region with the light emitted in the substantially horizontal direction.

### BRIEF SUMMARY

Illustrative aspects of the present invention may provide a vehicle lamp which addresses the problem described above.

According to an illustrative aspect of the present invention, a vehicle lamp includes a projection lens which is arranged such that a center axis of the projection lens extends along a front-rear direction of a vehicle on which the vehicle lamp is mounted, an LED light source which is arranged behind a rear focal point of the projection lens such that an optical axis of the LED light source is oriented upward, a reflector which is arranged to cover the LED light source from above to reflect a first part of light emitted from the LED light source and to converge the first part of the light toward the rear focal point of the projection lens, a shade which is arranged between the projection lens and the reflector in the front-rear direction of the vehicle to partially block the first part of the light reflected by the reflector so as to form a cut-off line of a light distribution pattern, and a first auxiliary reflector which is arranged above the LED light source and in front of the reflector to forwardly reflect a second part of the light emitted from the LED light source such that the second part of the light does not pass through the projection lens.

Other aspects and advantages of the invention may be apparent from the following description, the drawings and the claims.

### BRIEF DESCRIPTION OF THE DRAWINGS

FIG. 1 is a front view of a vehicle lamp according to an exemplary embodiment of the present invention;

FIG. 2 is an enlarged sectional view of the vehicle lamp taken along the line II-II of FIG. 1, primarily illustrating a lamp unit of the vehicle lamp;

FIG. 3 is a sectional view of a vehicle lamp according to a modified example of the exemplary embodiment; and

FIG. 4 is a diagram illustrating iso-illuminance curves of an example of a light distribution pattern that is formed by the vehicle lamp.

### DETAILED DESCRIPTION

Hereinafter, an exemplary embodiment of the present invention will be described in detail with reference to the drawings. However, the following exemplary embodiment does not limit the scope of the claimed invention, and all combinations of features of the exemplary embodiment are not necessarily required to address the problem described above.

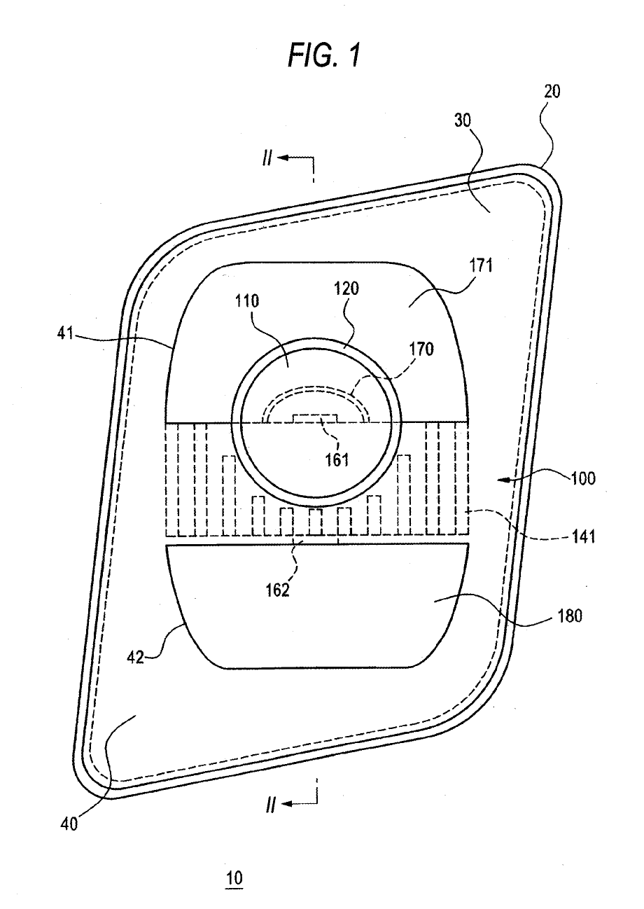

A vehicle lamp according to the exemplary embodiment is a headlamp 10 as shown in FIG. 1. In general, the headlamp 10 is arranged on a front part of a vehicle, and is operable to selectively irradiate a high beam and a low beam. In the following description, terms such as “front”, “rear”, “forward” and “rearward” are used with respect to a front-rear direction of the vehicle on which the headlamp 10 is to be mounted.

As shown in FIG. 1, the headlamp 10 includes a lamp body 20 having a front opening, a front cover 30 attached to the lamp body 20 to cover the front opening of the lamp body 20, and a lamp unit 100 disposed inside a lamp chamber defined by the lamp body 20 and the front cover 30. Between the lamp unit 100 and the front cover 30, an extension 40 is arranged so as to conceal a gap between the lamp unit 100 and the lamp body 20 in the front view of the headlamp 10.

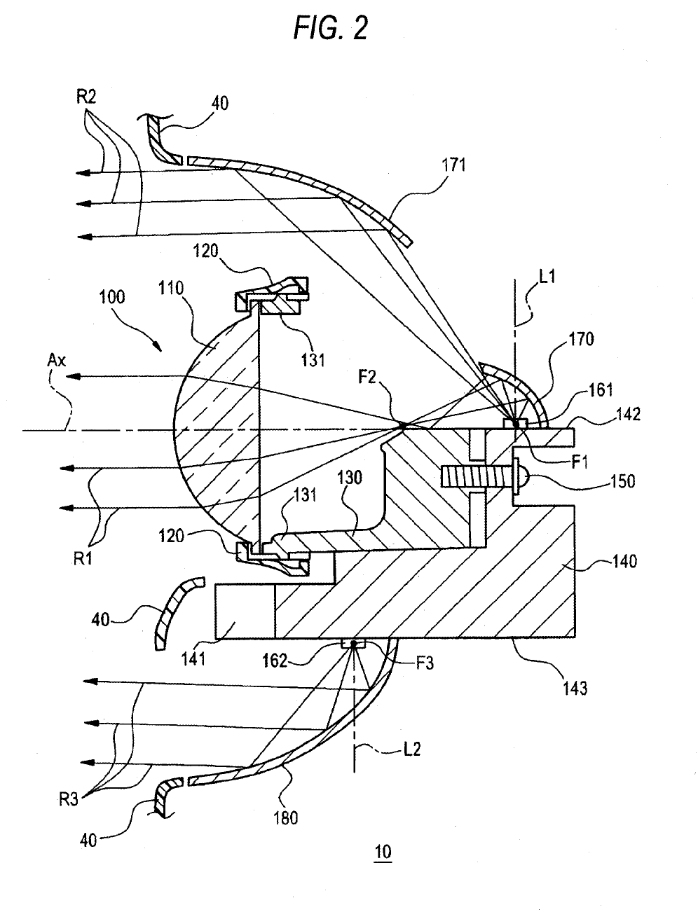

As shown in FIGS. 1 and 2, the lamp unit 100 includes a projection lens 110, a lens holder 120, a shade 130, a bracket 140, a fastener 150, LED light sources 161, 162, a reflector 170, a first auxiliary reflector 171, and a lower reflector 180. The lamp unit 100 is attached to the lamp body 20 via an aiming mechanism (not shown) so as to be tiltable with respect to the lamp body 20 so that an optical axis of the light irradiated from the lamp unit 100 can be adjusted.

The projection lens 110 is a plano-convex lens having a convex front surface and a flat rear surface. The projection lens 110 is arranged such that a center axis Ax of the projection lens 110 is substantially aligned with the front-rear direction of the vehicle. An outer circumferential portion of the projection lens 110 is held between an annular lens holder 120 and an annular portion 131 of the shade 130 so that the projection lens 110 is fixed in its position.

The shade 130 is disposed behind the projection lens 110, and is fixed to the bracket 140 via the fastener 150 such that a rear face and a bottom face abut the bracket 140. The fastener 150 may be a screw. Alternatively, the shade 130 may be fixed to the bracket 140 in a different manner, e.g., by bonding, without using the fastener 150.

The shade 130 is configured and arranged such that an upper horizontal surface of the shade 130 rearwardly extends from a vicinity of a rear focal point F2 of the projection lens 110 along the center axis Ax of the projection lens 110. A front edge of this upper horizontal surface in the vicinity of the rear focal point F2 extends in a widthwise direction of the vehicle, i.e., in a lateral direction in FIG. 1. The annular portion 131 is formed at a front side of the shade 130. As described above, the annular portion 131 holds the outer circumferential portion of the projection lens 110 together with the lens holder 120.

The bracket 140 is attached to the lamp body 20 via a fastener (not shown) so as to support the shade 130, the reflector 170, and the lower reflector 180. The bracket 140 has an upper horizontal surface 142, and is arranged such that the upper horizontal surface 142 extends along the center axis Ax of the projection lens 110 so as to be level with the upper horizontal surface of the shade 130. The LED light source 161 is placed on the upper horizontal surface 142 such that an optical axis L1 of the LED light source 161 is oriented upward. The bracket 140 also has a lower horizontal surface 143, on which the LED light source 162 is placed such that an optical axis L2 of the LED light source 162 is oriented downward.

The bracket 140 further has a plurality of heat sinks 141 which extend toward the front so as to increase a surface area of the bracket 140. In this exemplary embodiment, the bracket 140 is made of a material, such as aluminum, that has high heat conductivity. Thus, the bracket 140 efficiently dissipates heat generated by the LED light sources 161, 162.

Each of the LED light sources 161, 162 includes one or more LED chips, each being hermetically disposed inside a seal cover made of a transparent material such as a resin. In this exemplary embodiment, each of the LED light sources 161, 162 has rectangular upper and lower surfaces, which are longer in the widthwise direction than in the front-rear direction of the vehicle. The upper surface of the LED light source 161 is a light emitting surface which primarily emits light. As for the LED light source 162, the lower surface is a light emitting surface which primarily emits light. Each of the LED light sources 161, 162 are arranged such that a long side of the light emitting surface is substantially parallel to the widthwise direction of the vehicle. Electric power is fed to the LED light sources 161, 162 via a feeding circuit (not shown), respectively, to emit light from the LED light sources 161, 162.

The reflector 170 is configured and arranged so as to cover the LED light source 161 from above and from both sides such that the optical axis L1 of the LED light source 161 meets the reflector 170. A lower portion of the reflector 170 is fixed to the bracket 140 via a fastener (not shown). An inner surface of the reflector 170 that faces the LED light source 161 is a smoothly curved surface having a substantially elliptic cross section, and a highly reflective material is applied or deposited thereon. An inner surface of the reflector 170 has a first focal point substantially at a light emitting center F1 of the LED light source 161, and a second focal point substantially at the rear focal point F2 of the projection lens 110. Accordingly, the inner surface of the reflector 170 reflects a first part of light emitted from the LED light source 161, and converges the light toward the rear focal point F2.

The light that is converged toward the focal point F2 is partially cut off by the front edge of the shade 130, and the remaining part of the light is forwardly irradiated through the projection lens 110 as substantially parallel light rays R1. The light rays R1 form, for example, a light-condensed region of a low beam light distribution pattern that includes a cut-off line of the low beam light distribution pattern. The upper horizontal surface of the shade 130 may be minor finished so that the light from the LED light source 161 can more effectively be utilized.

The first auxiliary reflector 171 is arranged above and in front of the reflector 170. The reflector 170 and the first auxiliary reflector 171 may be formed as a one-piece structure. An inner surface of the first auxiliary reflector 171 is configured as a free curved surface which includes a group of sections of substantially parabolic surfaces, each having a focal point substantially at the light emitting center F1 of the LED light source 161. Further, similar to the inner surface of the reflector 170, a highly reflective material is applied or deposited on an inner surface of the first auxiliary reflector 171.

The inner surface of the first auxiliary reflector 171 reflects a second part of the light emitted from the LED light source 161 so as to forwardly irradiate the second part of the light without passing through the projection lens 110. More specifically, the first auxiliary reflector 171 is disposed above the projection lens 110, and reflects the second part of light, which is emitted in a forwardly inclined direction from the optical axis L1, toward a region above the projection lens 110. The light reflected by the first auxiliary reflector 171 is forwardly irradiated as substantially parallel light rays R2 without passing through the projection lens 110, but through an opening 41 of the extension 40. The light rays R2 form, for example, a light-diffused region of the low beam light distribution pattern which surrounds the light-condensed region.

FIG. 2 is an exemplary sectional view taken along a vertical plane and, thus, illustrates light paths of the second part of the light that are upwardly emitted from the LED light source 161 obliquely to the front within the vertical plane. However, the first auxiliary reflector 171 extends in the widthwise direction of the vehicle. Therefore, the second part of the light to be reflected by the first auxiliary reflector 171 and forwardly irradiated without passing through the projection lens 110 also includes upwardly emitted light from the LED light source 161 which is oriented obliquely to the front and toward the widthwise direction of the vehicle outside the vertical plane.

The lower reflector 180 is configured and arranged so as to cover the LED light source 162 from below and from both sides such that the optical axis L2 of the LED light source 162 meets the lower reflector 180. An upper portion of the lower reflector 180 is fixed to the bracket 140 via a fastener (not shown). An inner surface of the lower reflector 180 that faces the LED light source 162 is a free curved surface which includes a group of sections of substantially parabolic surfaces, each having a focal point substantially at a light emitting center F3 of the LED light source 162.

Similar to the inner surfaces of the reflector 170 and the first auxiliary reflector 171, a highly reflective material is applied or deposited on the inner surface of the lower reflector 180. The inner surface of the lower reflector 180 reflects light emitted from the LED light source 162 so as to forwardly irradiate the light through an opening 42 of the extension 40 as substantially parallel light rays R3. The light rays R3 form a high beam light distribution pattern.

According to the headlamp 10 of the exemplary embodiment described above, the light-diffused region of the low beam light distribution pattern is formed by using the second part of the light that is emitted obliquely upwards from the LED light source 161. Therefore, as compared with, for example, a case where the same region is formed by using light emitted substantially in the horizontal direction from the LED light source 161, a larger amount of light can be used for the formation of the light-diffused region. As a result, the illuminance required for the light-diffused region can sufficiently be ensured.

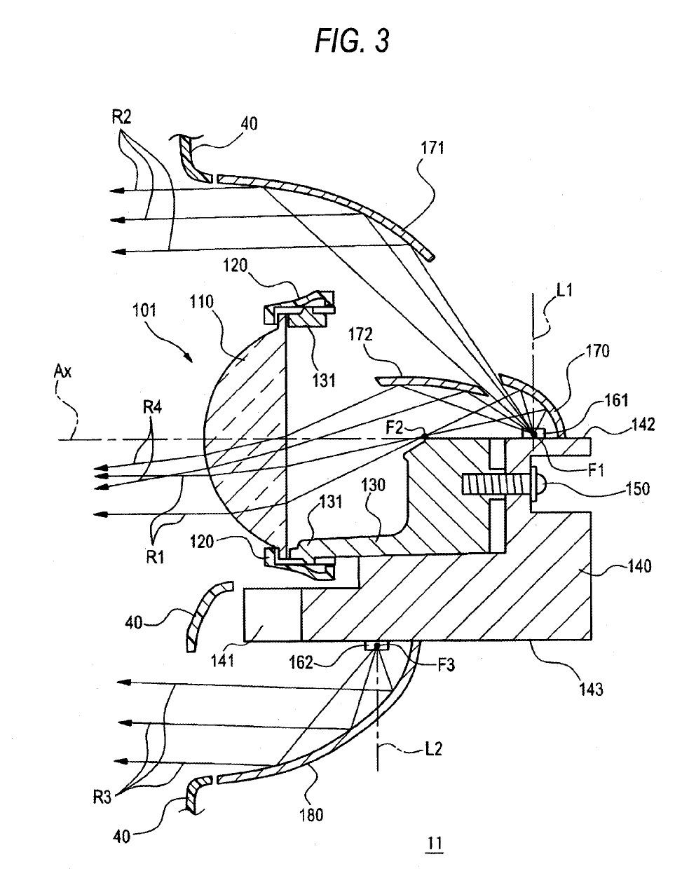

FIG. 3 is a sectional view of a vehicle headlamp 11 according to a modified example of the exemplary embodiment, which is also taken along the vertical plane. In the following description of the modified example and in FIG. 3, the same reference numerals and signs will be given to the components of the vehicle headlamp 11 that are the same as or similar to those of the headlamp 10 shown in FIGS. 1 and 2, and the repetitive description will be omitted.

The headlamp 11 includes a lamp unit 101 instead of the lamp unit 100 of the headlamp 10. The lamp unit 101 has a second auxiliary reflector 172 disposed below the first auxiliary reflector 171. More specifically, the secondary reflector 172 is arranged in front of the reflector 170 and between the LED light source 161 and the first auxiliary reflector 171. The second auxiliary reflector 172 and the reflector 170 may be formed as a one-piece structure. In such a case, an opening is formed between the reflector 170 and the second auxiliary reflector 172 to pass the second part of the light towards the first auxiliary reflector 171 (see a gap between the reflector 170 and the second auxiliary reflector 172 in FIG. 3). The first auxiliary reflector 171 may be formed as a separate structure from the reflector 170 and the second auxiliary reflector 172, so that the first auxiliary reflector 171 can be made smaller to have a size that at least satisfies an effective reflection surface.

An inner surface of the second auxiliary reflector 172 is a free curved surface which is designed to reflect a third part of the light from the LED light source 161 toward the center axis Ax of the projection lens 110 so that the third part of the light passes through the projection lens 110. The inner surface of the second auxiliary reflector 172 and the inner surface of the first auxiliary reflector 171 may be given different curvatures from each other. Similarly to the inner surface of the reflector 170, a highly reflective material is applied or deposited on the inner surface of the second auxiliary reflector 172.

The second auxiliary reflector 172 is configured and arranged to reflect the third part of the light emitted from the LED light source 161, which is not reflected by the reflector 170 or the first auxiliary reflector 171. More specifically, the second auxiliary reflector 172 is arranged on light paths of the third part of the light emitted from the LED light source 161, which otherwise would be blocked by the annular portion 131 of the shade 130 and the lens holder 120 for example in the lamp unit 100. The inner surface of the second auxiliary reflector 172 reflects the third part of the light emitted from the LED light source 161 so as to cause the third part of the light to be incident on the projection lens 110 from a region above the rear focal point F2 of the projection lens 110. The third part of the light reflected by the second auxiliary reflector 172 is irradiated slightly downward (about 5° to 10° downward from the horizontal line) through the projection lens 110 as light rays R4. This light rays R4 increase the illuminance of a lower zone of the light-diffused region of the low beam light distribution pattern below the light-condensed region.

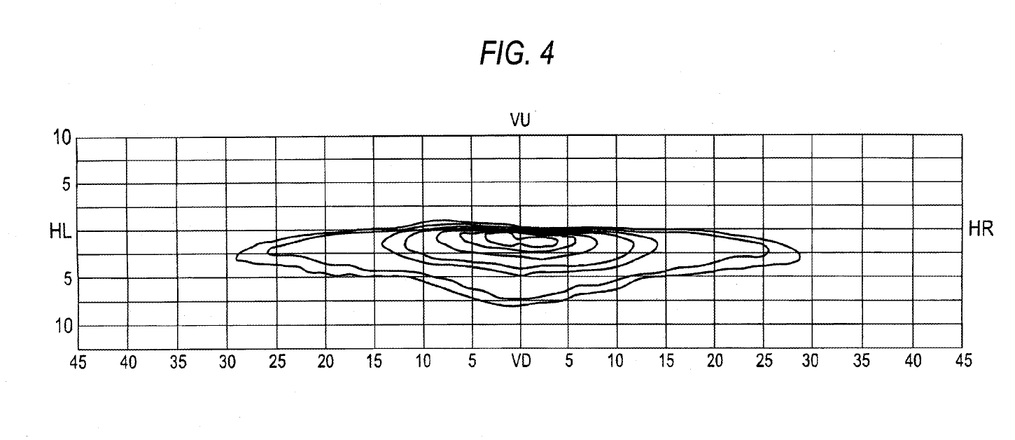

FIG. 4 is a diagram illustrating iso-illuminance curves of an example of a light distribution pattern formed by the vehicle headlamp 11. In FIG. 4, HL-HR denotes a horizontal reference line, and VU-VD denotes a vertical reference line. Numbers on the left side of the diagram denote angles toward the vertical direction from the horizontal reference line HL-HR, and numbers on a bottom side of the diagram denote angles toward the lateral direction from the vertical reference line VU-VD. The illuminance of the light-diffused region illustrated in FIG. 4 is higher than in a case of the headlamp 10, because the vehicle headlamp 11 effectively utilizes the third part of the light emitted from the LED light source 161 that is not used in the headlamp 10.

While the present invention has been described with reference to a certain exemplary embodiment thereof, the scope of the present invention in not limited to the exemplary embodiment described above, and it will be understood by those skilled in the art that various changes and modifications may be made therein.

What is claimed is:

1. A vehicle lamp comprising:
a projection lens which is arranged such that a center axis of the projection lens extends along a front-rear direction of a vehicle on which the vehicle lamp is mounted;
a first LED light source which is arranged behind a rear focal point of the projection lens such that an optical axis of the first LED light source is oriented upward;
a reflector which is arranged to cover the first LED light source from above to reflect a first part of light emitted from the first LED light source and to converge the first part of the light toward the rear focal point of the projection lens;
a shade which is arranged between the projection lens and the reflector in the front-rear direction of the vehicle to partially block the first part of the light reflected by the reflector so as to form a cut-off line of a light distribution pattern; and
a first auxiliary reflector which is arranged above the first LED light source and in front of the reflector to forwardly reflect a second part of the light emitted from the first LED light source such that the second part of the light does not pass through the projection lens.

2. The vehicle lamp according to claim 1, further comprising a second auxiliary reflector which is arranged below the first auxiliary reflector,
wherein the second auxiliary reflector reflects a third part of the light emitted from the first LED light source such that the third part of the light is incident on the projection lens from a region above the rear focal point of the projection lens.

3. The vehicle lamp according to claim 2, wherein the third part of the light is different from the first and second parts of the light.

4. The vehicle lamp according to claim 1, wherein the first LED light source has a light emitting surface which is longer in a widthwise direction of the vehicle than in the front-rear direction of the vehicle.

5. The vehicle lamp according to claim 1, further comprising:
a lamp body having a front opening; and
a front cover attached to the lamp body to cover the front opening,
wherein the lamp body and the front cover form a lamp chamber, and
the projection lens, the first LED light source, the reflector, the shade, and the first auxiliary reflector are arranged inside the lamp chamber as a lamp unit.

6. The vehicle lamp according to claim 1, wherein the second part of the light is emitted from the first LED light source in an upward direction toward a region above the projection lens.

7. The vehicle lamp according to claim 1, wherein the light distribution pattern includes a light-condensed region adjacent to the cut-off line and a light-diffused region surrounding the light condensed region,
wherein the light-condensed region has higher illuminance than the light-diffused region, and
wherein the first part of the light forms the light-condensed region and the second part of the light forms the light-diffused region.

8. The vehicle lamp according to claim 2, further comprising a lens holder which holds an outer circumferential portion of the projection lens, wherein the third part of the light is emitted from the first LED light source in a direction toward the lens holder.

9. The vehicle lamp according to claim 2, wherein the light distribution pattern includes a light-condensed region adjacent to the cut-off line and a light-diffused region surrounding the light condensed region,
wherein the light-condensed region has higher illuminance than the light-diffused region,
wherein the first part of the light forms the light-condensed region and the second and third parts of the light form the light-diffused region, and
wherein the third part of the light forms a portion of the light-diffused region below the light-condensed region.

10. The vehicle lamp according to claim 5, further comprising an extension which is arranged inside the lamp chamber to conceal a gap between the lamp unit and the lamp body in a front view of the vehicle lamp,
wherein the extension is formed with an opening through which the second part of the light is forwardly irradiated.

11. The vehicle lamp according to claim 1, further comprising:
a second LED light source disposed such that an optical axis of the second LED light source is oriented downward; and
a second reflector including a parabolic surface having a focal point substantially at a light emitting center of the second LED light source,
wherein the second reflector is arranged to cover the second LED light source from below to reflect light emitted from the second LED light source as substantially parallel light rays, and
wherein the substantially parallel light rays form a high beam light distribution pattern.

12. The vehicle lamp according to claim 11, further comprising a second auxiliary reflector which is arranged below the first auxiliary reflector,
wherein the second auxiliary reflector reflects a third part of the light emitted from the first LED light source such that the third part of the light is incident on the projection lens from a region above the rear focal point of the projection lens.
